(19) United States
(12) Patent Application Publication
(10) Pub. No.: US 2014/0123780 A1
(43) Pub. Date: May 8, 2014

(54) APPARATUS FOR LOCATING UTILITY BOXES

(71) Applicant: George Baptista BAGANHA, Strathroy (CA)

(72) Inventor: George Baptista BAGANHA, Strathroy (CA)

(21) Appl. No.: 14/084,913

(22) Filed: Nov. 20, 2013

Related U.S. Application Data
(63) Continuation of application No. 13/311,173, filed on Dec. 5, 2011, now abandoned.
(60) Provisional application No. 61/419,310, filed on Dec. 3, 2010.

(51) Int. Cl. G01B 21/16

(52) U.S. Cl. CPC G01B 21/16
USPC 73/865.8

(57) ABSTRACT

A utility box locator adapted to locate a utility box secured behind a covering material, of the type having a cavity with an opening that faces the covering material when the utility box is secured behind the covering material and a rim about the opening. The apparatus includes (a) a base plate, the base plate comprising two substantially rectilinear lateral sides, a top substantially rectilinear side and a bottom substantially rectilinear side, the base plate configured to fit inside the cavity of the utility box or substantially on top of the utility box, the base plate including at least one locating means; (b) a base plate-to-utility box attachment means coupled to the base plate that allows for removably securing the base plate to the utility box other than by a strict one-to-one structural cooperation between the base plate and the utility box; and (c) a top plate having at least one sensor means of the locating means, the at least one sensor means of the top plate being capable of cooperating with the at least one locating means of the base plate to locate the utility box secured behind the covering material.

### CROSS REFERENCE TO RELATED APPLICATIONS

This application is a continuation of U.S. patent application Ser. No. 13/311,173 filed Dec. 5, 2011, which in turn claims the benefit of the filing date of U.S. Provisional Application No. 61/419,310 filed Dec. 3, 2010 by the present inventor, the contents of each of which are hereby specifically incorporated herein by reference into the present disclosure.

### FIELD OF THE INVENTION

The present invention relates to the technical field of rough building to construction. More particularly, the invention relates to an apparatus and method for locating utility boxes installed behind a wall, ceiling or flooring during the construction of buildings.

### BACKGROUND OF THE INVENTION

Conventional locating of utility boxes attached to studs and framing members is normally done with measuring devices (tape measure) in the field prior to installation of sheet material such as wallboard (drywall) paneling or metal soffit. This is a time consuming procedure and is potentially problematic due to human error and difficult determination of accurate measurements due to wall angles, and other factors. Material waste is also a financial issue in the various trades that depend on minimal waste produced and efficient use of time.

A number of devices have been described in the art that presumably facilitate locating utility boxes behind drywall. However, due to the disadvantages of these devices, the conventional method of locating utility boxes is the preferred method.

U.S. Pat. No. 7,434,327 (U.S. Pat. No. '327) describes an apparatus for locating devices behind a wall or ceiling such as electrical boxes. The apparatus consists of a first member positionable within an electrical box and a second member that can be positioned on the outer surface of the wall or ceiling. A magnet positioned in the first member cooperates with a magnet positioned in the second member to maintain the second member in an aligned position with respect to the electrical box. Two magnets can be used to enhance the alignment of the second member with the electrical box. The first member includes an outer surface shaped to conform to at least a portion of the inner surface of the body of the device to be located.

One disadvantage of the apparatus of U.S. Pat. No. '327 is that for the first member to remain in position within the utility box to be located, the first member must be shaped and sized to conform exactly with the inner surface of the body of the electrical box. That is, there must be a strict one-to-one structural cooperation between the first member and the electrical box. Other than its shape, nothing would keep the first member from slipping back and be re-positioned within the electrical box, in which case the second member may not be able to locate the first member.

U.S. Pat. No. '327 also discloses an apparatus for locating the box in the ceiling. In this case first member would tend to drop down because of gravitational forces. U.S. Pat. No. '327 does not teach or suggest how the first member is being kept in position and prevented from moving within or out of the utility box, either on a wall or ceiling.

Another disadvantage of the apparatus of U.S. Pat. No. '327 is that utility boxes or other devices come in different shapes and sizes, and may be made of different materials. Furthermore, different jurisdictions may have different regulations and requirements on electrical or other utility boxes. For example, electrical boxes in Canada are made of metal, are rectangular and do not have a boss extending from an inner surface. In this case, nothing would hold the first member of the apparatus of U.S. Pat. No. '327 in position within a rectangular electrical box not having a boss.

Yet another disadvantage of U.S. Pat. No. '327 is that the apparatus relies solely on the cooperation between the magnets in the first member and the magnets in the second member to determine the location of the utility box.

Accordingly, it is a general object of the present invention to provide for an apparatus for locating utility boxes behind a wall or ceiling that can be secured to the utility box being located so that it remains in position within the utility box and prevented from any downward or lateral movement within the utility box.

### SUMMARY OF THE INVENTION

The present invention provides for a two piece apparatus that allows the user to locate utility box openings behind a covering member, such as drywall, paneling or plywood without the aid of measuring instruments.

As such, in one embodiment the present invention provides for a utility box locator adapted to locate a utility box mountable behind a covering material, the utility box including a cavity, the utility box being devoid of a boss or projection extending into the cavity of the utility box. In one embodiment, the utility box locator includes: (a) a base plate configured to fit inside the cavity of the utility box or substantially on top of the utility box, the base plate including at least one locating means; (b) a base plate-to-utility box attachment means coupled to the base plate that allows for removably securing the base plate to the utility box other than by a strict one-to-one structural cooperation between the base plate and the utility box; and (c) a top plate having at least one sensor means of the locating means, the at least one sensor means of the top plate being capable of cooperating with the at least one locating means of the base plate to locate the utility box secured behind the covering material.

In another embodiment of the present invention, an apparatus is provided for locating a utility box secured behind a covering material, said utility box comprising a cavity having an inner surface and an open end facing the covering material, the apparatus comprising: (a) a base plate configured to fit inside the cavity or substantially on top of the open end, said base plate including a first and a second opposite surfaces joined by lateral walls and having attachment means disposed on said lateral walls for removably securing the base plate to the inner surface of said cavity, thereby preventing movement of the base plate with respect to the utility box; and (c) a top plate shaped having sensor means of the attachment means, the sensor means of the top plate capable of cooperating with the attachment means of the base plate to substantially align said top plate with the utility box secured behind the covering material.

In another embodiment of the present invention, an apparatus is provided for defining at least a portion of a perimeter of a utility box secured behind a covering material, said utility box comprising a cavity having an inner surface and an open end facing the covering material, the apparatus comprising: (a) a base plate configured to fit inside the cavity or substantially on top of the open end, said base plate including a first and a second opposite surfaces joined by lateral walls and having at least one locating means; (b) one or more attachment means for removably securing the base plate to the inner surface, thereby preventing movement of the base plate with respect to the utility box; and (c) a top plate having a perimeter defining means that substantially corresponds to the perimeter or a portion of the perimeter of the utility box, said top plate further including at least one sensor capable of cooperating with the at least one locating means of the base plate to substantially align said perimeter defining, means with the utility box.

In yet another embodiment, the present invention provides for a method of locating a utility box mounted behind a covering material, the utility box including a cavity, the utility box being devoid of a boss or projection extending into the cavity of the utility box, the method comprising: (a) providing the utility box mounted to a stud; (b) providing a utility box locator comprising (i) a base plate configured to fit inside the cavity of the utility box or substantially on top of the utility box, the base plate including at least one locating means; (ii) a base plate-to-utility box attachment means coupled to the base plate that allows for removably securing the base plate to the utility box other than by a strict one-to-one structural cooperation between the base plate and the utility box; and (iii) a top plate having at least one sensor means of the locating means, the at least one sensor means of the top plate being capable of cooperating with the at least one locating means of the base plate; (b) removably attaching the base plate to the utility box; (c) covering the utility box with the covering material; (d) moving the top plate about the covering material until the sensor means cooperates with the locating means, thereby locating the utility box secured behind the covering material.

In aspects of the invention, the one or more attachment means may be selected from the group consisting of: magnets, fastening tabs, spring loaded retention clamps, or Velcro®.

In aspects of the invention the utility box is made of a magnetically attractable material and said one or more attachment means include at least one magnet.

In aspects of the invention the locating means may comprise magnets, electronic sensors or a magnetically attractable material.

In aspects of the invention the sensors of the locating means comprise magnets, electronic sensor devices, or a magnetically attractable material.

### BRIEF DESCRIPTION OF THE DRAWINGS

The construction of the invention will be described in reference to the accompanying drawings in which:

FIG. 1 illustrates a perspective view of an apparatus of the present invention coupled to a double gang electrical box.

FIG. 2: Exploded isometric view of the base and top plates detailing magnet and tension tabs in single gang configuration and location/orientation on base plate in single and dual metal device box in accordance with one embodiment of the present invention.

FIG. 3: illustrates a perspective view of an apparatus of the present invention coupled to a single gang electrical box.

FIG. 4 A illustrates a front view of a top plate designed for surface octagonal utility boxes, in accordance with one embodiment of the present invention; FIG. 4 B illustrates the back view of the top plate of FIG. 4 A; FIG. 4 C illustrates side view of the top plate of FIG. 4 A; and FIG. 4 D illustrates another side view of the top plate of FIG. 4 A.

FIG. 5 A illustrates a front view of a base plate designed for insertion into an octagonal utility box in accordance with one embodiment of the present invention; FIG. 5 B illustrates the back view of the base plate of FIG. 5 A; FIG. 5 C illustrates a side view of the base plate of FIG. 5 A; and FIG. 5 D illustrates another side view of the base plate of FIG. 5 A.

FIG. 6 A illustrates a front view of a base plate designed for insertion into a single gang metal utility box in accordance with one embodiment of the present invention; FIG. 8 B illustrates the back view of the base plate of FIG. 6 A; FIG. 6 C illustrates side view of the base plate of FIG. 6 A; and FIG. 6 D illustrates an end view of the base plate of FIG. 6 A.

FIG. 7 A illustrates a front view of top plate designed for locating single gang metal utility boxes in accordance with one embodiment of the present invention: FIG. 7 B illustrates the back view of the top plate of FIG. 7 A; FIG. 7 C illustrates a side view of the top plate of FIG. 7 A, and FIG. 7 D illustrates an end view of the top plate of FIG. 7 A.

FIG. 8 A is a front view of a base plate designed for insertion into a dual gang metal utility box in accordance with one embodiment of the present invention; FIG. 8 B illustrates the back view of the base plate of FIG. 8 A; FIG. 8 C illustrates a side view of the base plate of FIG. 8 A: and FIG. 8 D illustrates an end view of the base plate of FIG. 8 A.

FIG. 9 A illustrates a front view of a top plate designed for locating dual gang metal utility boxes in accordance with one embodiment of the present invention; FIG. 9 B illustrates the back view of the top plate of FIG. 9 A; and FIG. 9 C illustrates a side view of the top plate of FIG. 9 A.

FIG. 10 A illustrates a front view of a base plate designed for insertion into a three gang metal utility box in accordance with one embodiment of the present invention: FIG. 10 B illustrates the back view of the base plate of FIG. 10 A; FIG. 10 C illustrates a side view of the base plate of FIG. 10 A; and FIG. 10 D illustrates an end view of the base plate of FIG. 10 A.

FIG. 11A illustrates a front view of a top plate designed for locating three gang metal utility boxes in accordance with one embodiment of the present invention; FIG. 11B illustrates the back view of the top plate of FIG. 11A; and FIG. 11C illustrates an end view of the top plate of FIG. 11A.

FIG. 12 A illustrates a front view of a base plate designed for insertion into a four gang metal utility box in accordance with one embodiment of the present invention; FIG. 12 B illustrates the back view of the base plate of FIG. 12 A; FIG. 10 C illustrates a side view of the base plate of FIG. 12 A; and FIG. 12 D illustrates an end view of the base plate of FIG. 12 A.

FIG. 13 A is a front view of a top plate designed for locating four gang metal utility boxes in accordance with one embodiment of the present invention: and FIG. 13 B illustrates the side view of the top plate of FIG. 13 A.

### DETAILED DESCRIPTION OF THE INVENTION

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise.

The term “utility box” refers to utilities for servicing the rooms, such as electrical wiring, water pipes and gas lines that may be mounted to studs. The term also refers to air vents. Although termed “utility box”, utility boxes may take different shapes and sizes. Shapes include rectangular, square, octagonal, or circular. For to example utility boxes for mounting on the walls may usually take a substantially rectangular shape, while utility boxes for mounting on the ceiling may take a substantially circular shape.

The present invention provides for an apparatus for locating a utility box mounted behind a covering material to a structural framing member.

In one embodiment the present invention provides for an apparatus for locating a utility box which may be secured behind a covering material. The utility box may include a cavity and an open end facing the covering material, the apparatus may include: (a) a base plate configured to fit inside the cavity or substantially on top of the open end, the base plate may include a first and a second opposite surfaces joined by lateral walls and having locating means such as magnets, electronic sensors, or magnetically attractable materials; (b) one or more attachment means, such as magnets, fastening tabs, spring loaded retention clamps, or Velcro®, for removably securing the base plate to the inner surface, such as to prevent movement of the base plate with respect to the utility box; and (c) a top plate having sensor means of the locating means, such as magnets, electronic sensor devices, or a magnetically attractable material, that may cooperate with the locating means of the base plate to substantially align said top plate with the utility box placed behind the covering material.

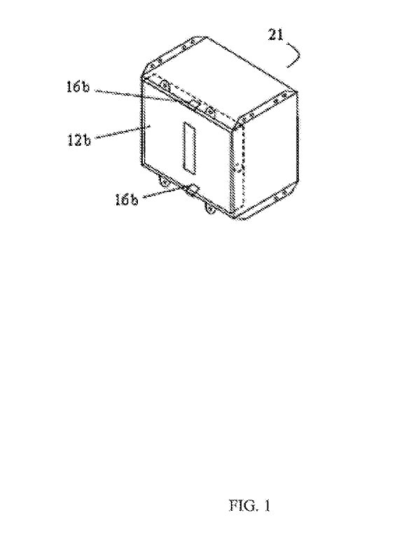

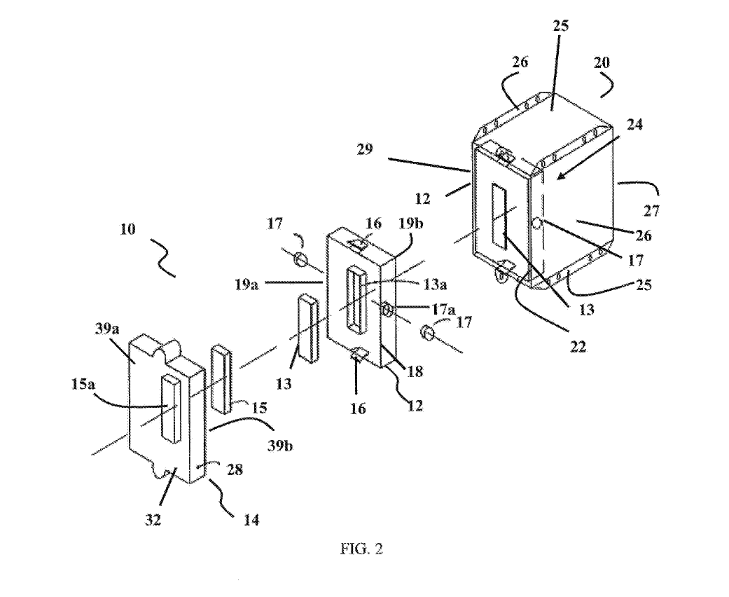

Referring to FIG. 1 and FIG. 2, two utility boxes are depicted: a single gang 20 illustrated in FIG. 2, and a double gang 21 shown in FIG. 1. Although the description below will refer mostly to the single gang utility box 20, it should be understood that the present invention may be used for any type of utility boxes (single or multiple-gang). Utility box 20 is shown with substantially rectilinear construction and includes upright sidewalls 26, top and bottom walls 25, and rear wall 27. Side walls 26, bottom walls 25, and rear wall 27 define a cavity 24 having an opening 22, which is opposite to rear wall 27. Opening 22 is defined by a rim 29. FIG. 2 also illustrates a base plate 12 of the apparatus of the present invention removably secured within the cavity 24 of the utility box 20 with attachments 16 and 17. Utility box 21 is also shown with a corresponding base plate 12b removably secured within the cavity of utility box 21 with attachments 16b and 17b.

Referring to FIG. 2, there is shown an exploded view of an apparatus 10 for to locating a utility box, which may be mounted behind a sheet or covering material to a structural framing member (not shown), in accordance to one embodiment of the present invention. The apparatus 10 may include (i) a base plate 12 configured for positioning inside the cavity 24 of the utility box 20 or for positioning substantially on top of the opening 22, and having at least one locator 13, (ii) one or more attachments 16, 17 to removably secure the base plate 12 to side walls 26 or the bottom and top walls 25 of the utility box 20, and (iii) a top plate 14 having at least one sensor 15 of the locator 13 on the base plate 12. Top plate 14 may have a perimeter 32 of size and shape approximating the rim 29 of the utility box 20. The at least one sensor 15 of the top plate 14 may be capable of interacting and substantially cooperate with the at least one locator 13 of the base plate 12 to locate the utility box 20 behind the covering material. The perimeter 32 of the top plate 14 may substantially align with the rim 29 of the utility box 20.

With continued reference to FIG. 2, base plate 12 may include two opposite main surfaces, a first surface 19a and a second surface 19b. First face 19a would be facing the covering material when the base plate 12 is disposed within the utility box 20. The two surfaces 19a,b may be joined by lateral walls 18. The opposite surfaces 19a,b may include one or more adaptations for substantially securing the locators in place. The adaptations may be, for example, having a hole 13a expanding through the opposite surfaces 19a,b, or may be a cavity in either one of the two opposite surfaces sized for substantially securing the locator in place.

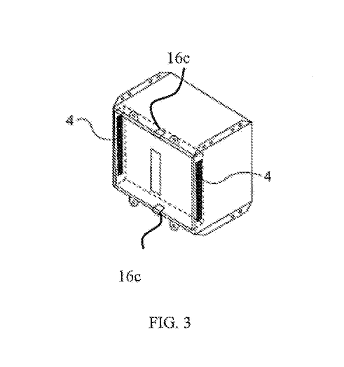

To removably secure the base plate 12 to the utility box 20, the base plate 12 includes one or more attachments 17. Attachments 17 may be coupled to the base plate and may allow for removably securing the base plate to the utility box other than by a strict one-to-one structural cooperation between the base plate and the utility box. The attachments may be disposed on the lateral walls 18. The lateral walls 18 may, for example, include adaptations for substantially securing the one or more attachments 17. For example, at least one well or cavity 17a may be included in the lateral walls 18 for substantially securing the one or more attachments 17. With reference to FIGS. 1, 2 and 3, attachments that may be used include tension tabs (spring loaded) 16, 16b, 16c, magnets 17, 17b, fastening tabs (not shown). Velcro® 4, or any combination thereof. FIG. 2 illustrates upper and lower tension tabs (spring loaded) 16 and lateral magnets 17 as attachments, however a skilled person in the art would understand that all side attachments may be tension tabs, or all may be magnets, or the upper and lower side attachments may be magnets and the lateral attachments may be tension tabs, or any combination thereof.

In one embodiment the base plate may be sized to substantially cover the opening of the utility box, such that the base plate protects the contents of the utility box during the installation of the covering material.

With continued reference to FIG. 2, top plate 14 may include two opposite main surfaces, a first surface 39a and a second surface 39b. In operation, the second surface 39b would face the first surface 19 of the base plate 12. The two main surfaces 39a,b may be joined by lateral walls 28. The opposite surfaces 39a,b may include a one or more securing features for substantially securing the at least one sensor means 15 in place. For example opposite faces may include a hole 15a that expands from one surface to the opposite surface, or it may be a cavity in either one of the two opposite faces designed for substantially securing the sensor means 15 in place. The perimeter 32 of the top plate 14 may be shaped to substantially correspond to the rim of the utility box to be located.

In one embodiment the locators and sensors on the base and top plates may be magnets. Due to magnetic attraction, the base and top plates may align themselves together and the top plate would be secured to the outer surface of the covering material. The perimeter of the top plate may then provide the operator a template to substantially trace the perimeter of the hidden body behind the covering material.

In one embodiment the locators and sensors on the base and top plates may comprise electronic sensors. In this embodiment of the invention a signal on the top plate may indicate the location of the utility box behind the covering member, and provide the operator a template to substantially trace the perimeter of the hidden body behind the covering member.

In one embodiment, the base plate may be made of a magnetically attractable material. In this embodiment the top plate may include at least one magnet that would detect the base plate behind the covering material by magnetic attraction to the base plate.

In embodiments of the present invention the sensors may include both an electronic sensor, for determining the approximate location of the body behind the covering member, and magnetic sensors for substantially fixing the second member to the outer surface of the covering member thereby facilitating the tracing of the perimeter.

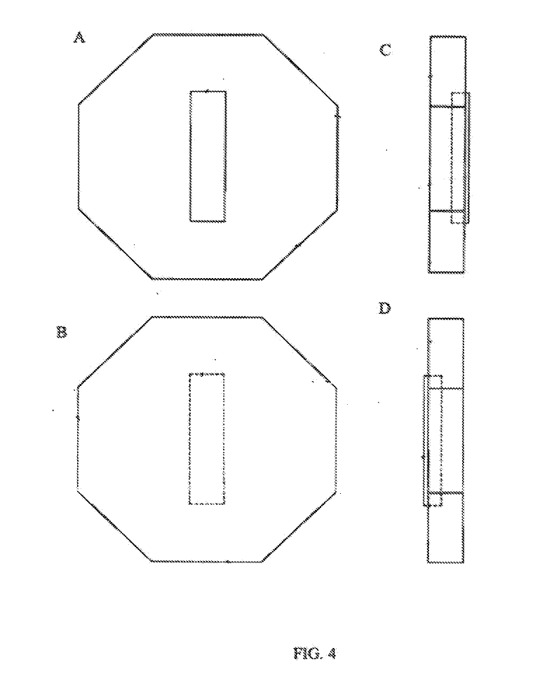

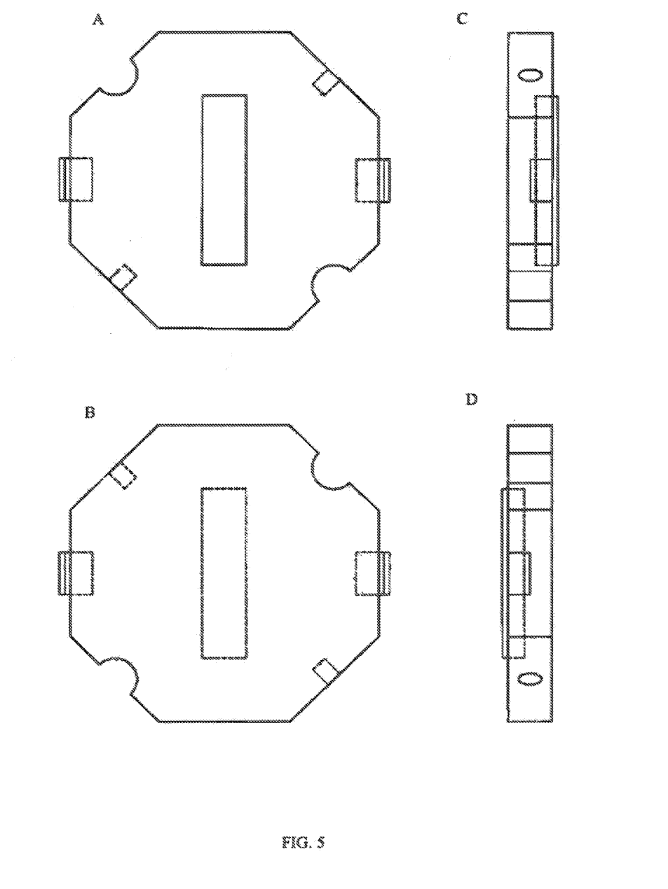

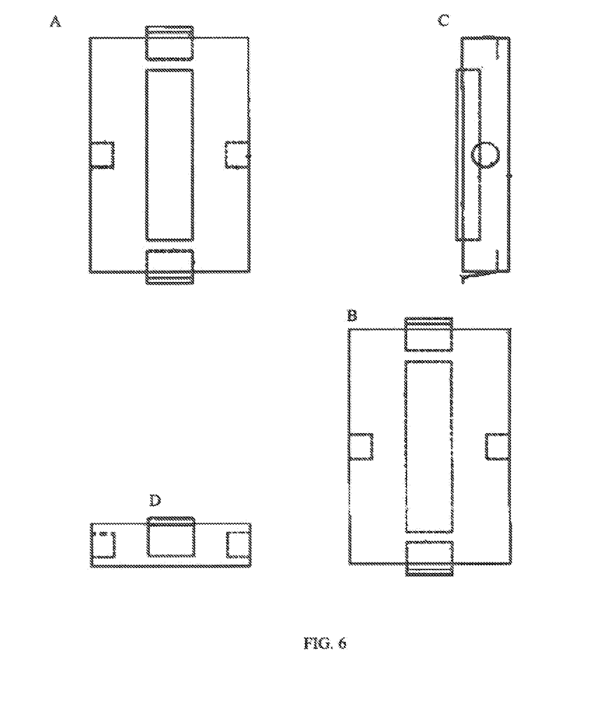

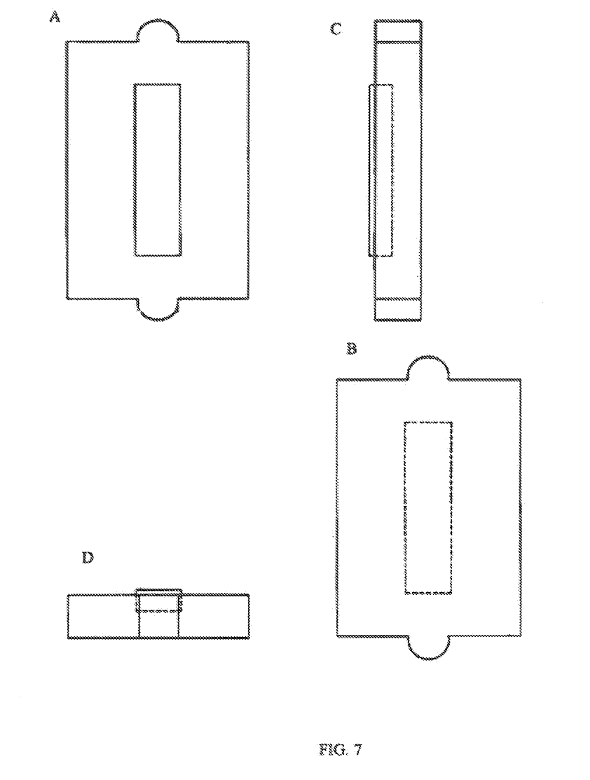

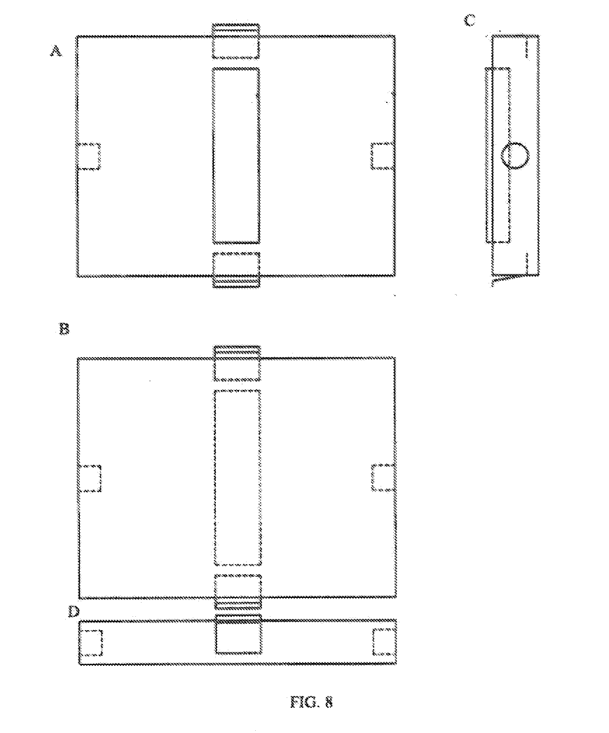

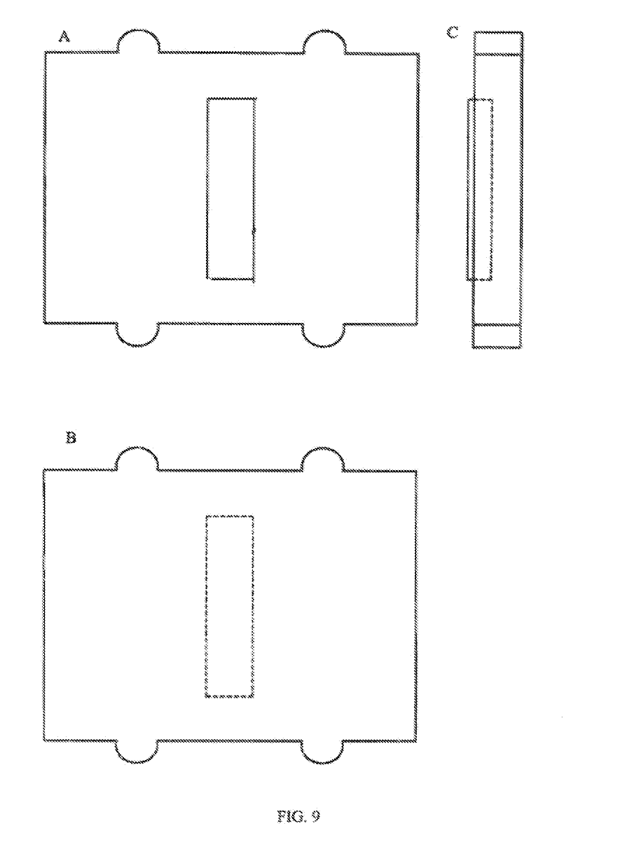

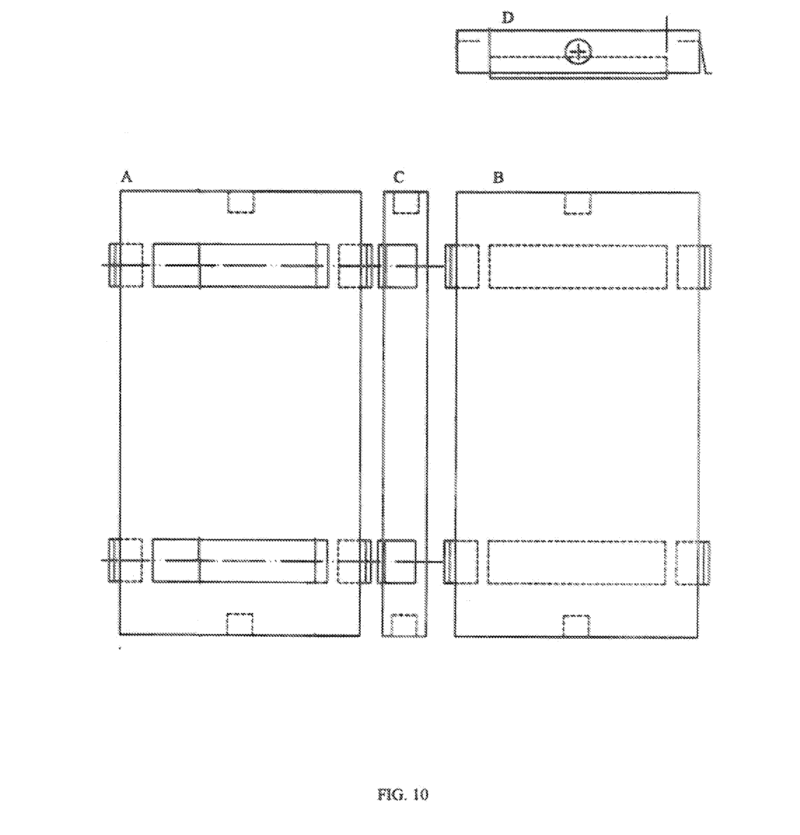

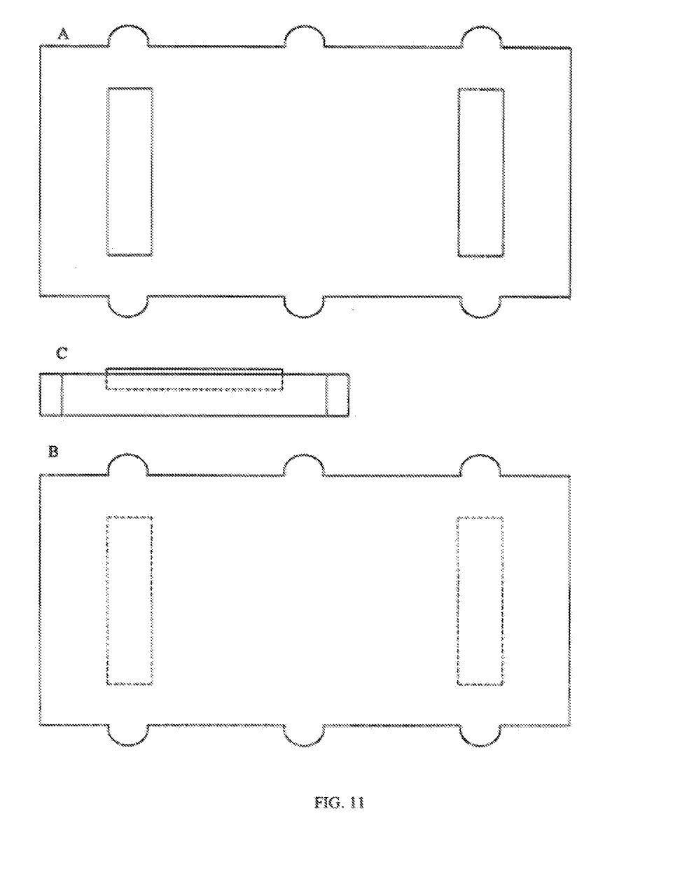

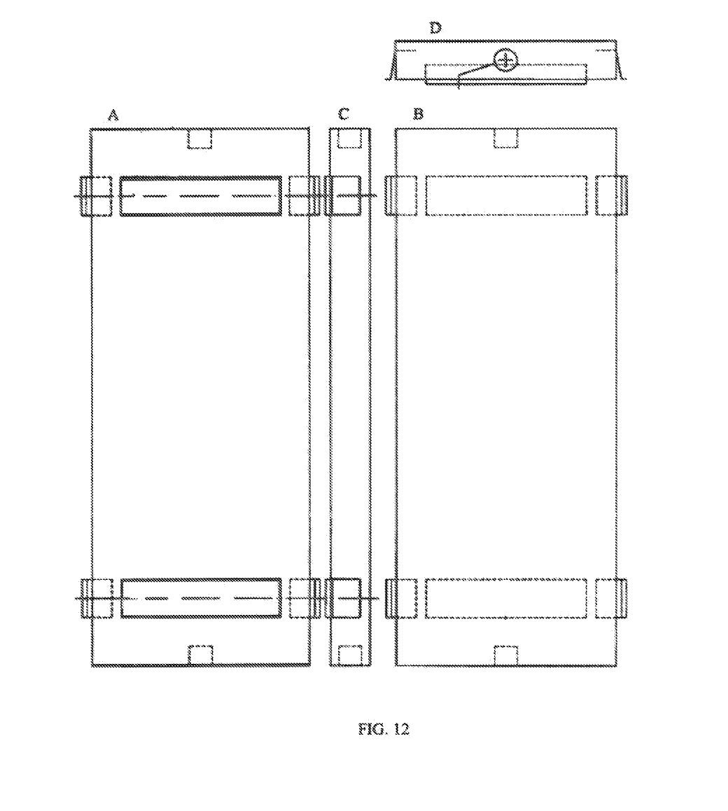

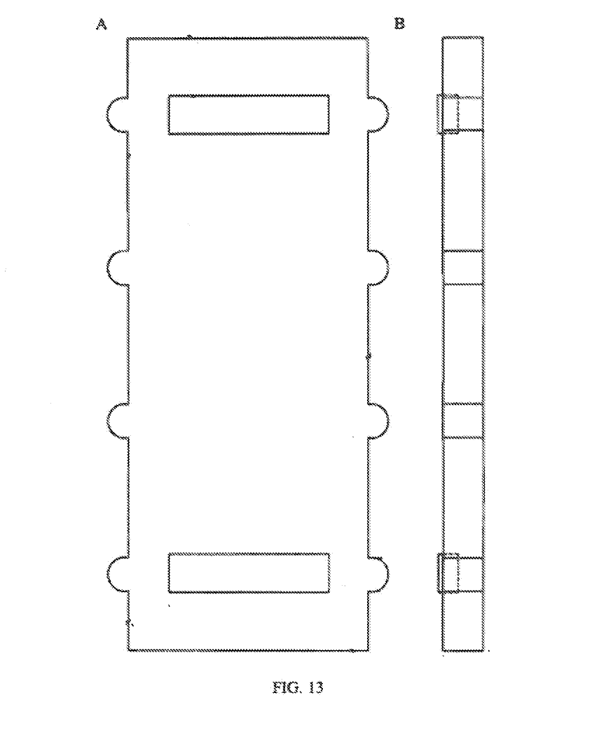

It should be understood that the utility box being located may take different shapes and forms, such as for example circular shapes, octagonal shapes, rectangular shapes, in which case the base plate and the top plate would take a circular, octagonal (see FIGS. 4 and 5) or rectangular (see FIGS. 1-3 and 6-13) shape to correspond to the shape of the utility box, and the side attachments may be disposed around the periphery of the base plate. Utility boxes may also be single gang, double gang, three-gang, four-gang and so forth, in which case the top and base plate will be sized to correspond to and for insertion in single gang (FIGS. 2-3, 6, 7), dual gang (FIGS. 1, 8, 9). three-gang (FIGS. 10, 11), four-gang (FIGS. 12, 13 and so forth.

During construction of a building or restoration of rooms, such as finishing basements, utility boxes may be secured to a frame or structure in the building, with the opening of the utility box facing the interior of the room. The base plate may be removably secured within the cavity or substantially on top of the opening by the attachments located on the lateral walls of the base plate.

Typically, the frame structure of a building may then be loosely covered with some type of sheathing or covering material such as gypsum board, paneling, aluminium or plywood, thereby covering the opening of the utility box with the base plate removably secured within the cavity of the utility box or substantially on top of the opening of the cavity. The top plate may then be swept across the surface of the covering material at the approximate location of the utility box. Location of utility box may then be attained by use of top plate by means of magnetic attraction to magnet on base plate or magnetically attractable materials or electronic proximity and/or magnetic sensor.

The locators and sensors on the base and top plates may cooperate to substantially align the top plate with the rim or perimeter of the utility box. The rim of the box may then be traced on the outer surface of the covering material.

The traced location of the utility box may then be ready for sheet material cut-out with a manual saw or a rotary tool. The base plate of the apparatus may then be removed from the utility box. After the sheet material has been cut out, the covering material may then be permanently attached to the frame or other building structure.

Various sizes and shapes of the base plate and top plate may be created to accommodate varying shapes and sized utility boxes.

The interaction of the first and second plates of the apparatus of the present invention provides the operator with the location of the device box without physical altering the sheathing covering material. The plates would be arranged in such a way in order to maximize axial attraction. The base plate should also be formed in such a way as to not interfere or inhibit components within device box. The base plate will provide a substantial degree of protection of components within device box by its very size occupying the majority of the cavity of the device box from cutting instruments whether manual or motorized.

In one embodiment the present invention provides for a kit for an apparatus for locating. The kit may comprise: first plate, second plate, one or more sensors, one or more locators, and side attachments.

The above disclosure generally describes the present invention. Although the description above contains many specifications, these should not be construed as limiting the scope of the invention but as merely providing illustrations of some of the embodiments of this invention. Thus the scope of the invention should be determined by the appended claims and their legal equivalents, rather than b the examples given.

I claim:

1. A utility box locator adapted to locate a utility box mountable behind a covering material, the utility box including a cavity, the utility box being devoid of a boss or projection extending into the cavity of the utility box, the utility box locator comprising: (a) a base plate configured to fit inside the cavity of the utility box or substantially on top of the utility box, the base plate including at least one locating means; (b) a base plate-to-utility box attachment means coupled to the base plate that allows for removably securing the base plate to the utility box other than by a strict one-to-one structural cooperation between the base plate and the utility box; and (c) a top plate having at least one sensor means of the locating means, the at least one sensor means of the top plate being capable of cooperating with the at least one locating means of the base plate to locate the utility box secured behind the covering material.

2. The utility box locator of claim 1, wherein the one or more attachment means are selected from the group consisting of: magnets, tension tabs, and Velcro®.

3. The utility box locator of claim 1, wherein the utility box is made of a magnetically attractable material and said one or more attachment means include at least one magnet.

4. The utility box locator of claim 1, wherein the at least one locating means is an electronic sensor.

5. The utility box locator of claim 1, wherein the at least one sensor means of the locating means is an electronic sensor device.

6. The utility box locator of claim 1, wherein the utility box is single gang or multiple gang.

7. The utility box locator of claim 1, wherein the utility box is secured behind a ceiling.

8. The utility box locator of claim 1, wherein the utility box is secured behind a wall.

9. The utility box locator of claim 1, wherein the base plate comprises two substantially rectilinear lateral sides, a top substantially rectilinear side and a bottom substantially rectilinear side, and wherein the attachment means are disposed on the lateral sides of the base plate.

10. A method of locating a utility box mounted behind a covering material, the utility box including a cavity having a substantially rectilinear perimeter, the utility box being devoid of a boss or projection extending into the cavity of the utility box, the method comprising:
(a) providing the utility box mounted to a stud;
(b) providing a utility box locator comprising (i) a base plate configured to fit inside the cavity of the utility box or substantially on top of the utility box, the base plate including at least one locating means; (ii) a base plate-to-utility box attachment means coupled to the base plate that allows for removably securing the base plate to the utility box other than by a strict one-to-one structural cooperation between the base plate and the utility box; and (iii) a top plate having at least one sensor means of the locating means, the at least one sensor means of the top plate being capable of cooperating with the at least one locating means of the base plate;
(b) removably attaching the base plate to the utility box;
(c) covering the utility box with the covering material;
(d) moving the top plate about the covering material until the sensor means cooperates with the locating means, thereby locating the utility box secured behind the covering material.
